(19) United States
(12) Patent Application Publication
(10) Pub. No.: US 2012/0139915 A1
(43) Pub. Date: Jun. 7, 2012

(54) OBJECT SELECTING DEVICE, COMPUTER-READABLE RECORDING MEDIUM, AND OBJECT SELECTING METHOD

(76) Inventors: Masahiro Muikaichi, Osaka (JP); Yuki Shinomoto, Osaka (JP); Kotaro Hakoda, Osaka (JP)

(21) Appl. No.: 13/389,125

(22) PCT Filed: May 10, 2011
(86) PCT No.: PCT/JP2011/002587

§ 371 Date: Feb. 6, 2012

(30) Foreign Application Priority Data
Jun. 7, 2010 (JP) 2010-130050

(51) Int. Cl. G06T 15/00

(52) U.S. Cl. 345/419

(57) ABSTRACT

A depth selector 18 selects a depth selecting position indicating a position along a depth axis Z, based on a depth selection command to be inputted by a user. A display judger 19 judges whether each of real objects RO is located on a forward side or on a rearward side with respect to the depth selecting position Zs in a depth space, and extracts real objects RO located on the reward side, as real objects RO to be displayed, in each of which a tag T1 is displayed. A drawing section 22 determines, on a display screen, a display position of each of the real objects RO to be displayed which have been extracted by the display judger 19 to draw the tags T1 at the determined display positions.

### TECHNICAL FIELD

The present invention relates to a technology of allowing a user to select from among a plurality of objects displayed three-dimensionally on a display image.

### BACKGROUND ART

In recent years, a technology called augmented reality has been focused. Augmented reality is a technology of additionally displaying information on a real world video. The technology includes e.g. displaying, on a head mounted display, a real world video and a virtual object in an overlaid manner, and a simplified arrangement of displaying a video captured by a camera and additional information in an overlaid manner on a display section of a mobile terminal such as a mobile phone.

In the case where a mobile terminal is used, it is possible to implement augmented reality without specifically adding a particular device, because the mobile terminal is equipped in advance with functions such as a GPS, an electronic compass, and network connection. Thus, in recent years, a variety of applications capable of implementing augmented reality have been available.

In these applications, an image captured by a camera, and additional information on an object in the real world, which is included in the captured image are displayed in an overlaid manner. However, in the case where the number of additional informations is large, a screen may be occupied by the additional informations.

In view of the above, there is used an element called as tags. A tag notifies a user that another object behind a certain object includes additional information, rather than notifying the additional information itself. In response to selecting a tag by a user, additional information correlated to the selected tag is notified to the user.

However, each of the tags is very small, and the number of tags is increasing. As a result, in the case where the user tries to select a tag, the user may find it impossible to select the tag because the tags overlap each other and the intended tag is behind the other tag(s), or the user may find it difficult to select an intended tag because the tags are closely spaced. In particular, in the case where the user manipulates on a touch-panel mobile terminal, the user finds it difficult to accurately select an intended tag from among the closely spaced tags, because the screen is small relative to the size of the user's fingertip.

In the foregoing, there has been described an example, wherein a tag is selected in augmented reality. In the case where a specific object is selected from among many objects three-dimensionally displayed on a display image, substantially the same drawback as described above may occur. For instance, there is a case that multitudes of photos are three-dimensionally displayed on a digital TV, and the user may select a specific one from among the multitudes of photos. In this case, substantially the same drawback as described above may occur.

In view of the above, there is known a technology of successively displaying objects arranged in the depth direction of a screen in a highlighted manner by user's manipulation of a button on an input device, and allowing the user to select an intended object when the intended object is highlight-displayed for easy selection of an object behind the other object(s).

Further, there is also known a technology of allowing a user to select a group of a certain number of three-dimensional objects which overlay each other in the depth direction of a screen from a certain position on the screen selected with use of a two-dimensional cursor, and to select an intended object from among the selected group of objects (see e.g. patent literature 1).

In the former technology, however, the user is required to press a certain number of buttons until an intended object is highlight-displayed, and a certain time is required until the intended object is selected. Further, in the latter technology, in the case where the entirety of an intended object is concealed, it is difficult to specify the position of the intended object, and in the case where the user manipulates the device by the touch panel method, a designated position may be displaced from an intended position, with the result that an object at an unwanted position may be selected.

### CITATION LIST

### Patent Literature

JP Hei 8-77231A

### SUMMARY OF INVENTION

An object of the invention is to provide a technology that allows a user to accurately and speedily select an intended object from among three-dimensionally displayed objects.

An object selecting device according to an aspect of the invention is an object selecting device which allows a user to select from among a plurality of objects three-dimensionally displayed on a display section. The object selecting device includes a drawing section which determines a display position of each of the objects on the display section, based on a position of each of the objects disposed in a predetermined depth space, to draw each of the objects at the determined display position; a depth selector which selects a depth selecting position indicating a position for defining the depth space along a depth axis, based on a depth selection command to be inputted from the user; and a display judger which judges whether each of the objects is located on a forward side or on a rearward side with respect to the depth selecting position in the depth space to extract only the objects located on the rearward side, as objects to be displayed. In this arrangement, the drawing section draws the objects to be displayed which have been extracted by the display judger.

An object selecting program according to another aspect of the invention is an object selecting program which causes a computer to function as an object selecting device which allows a user to select from among a plurality of objects three-dimensionally displayed on a display section. The object selecting device includes a drawing section which determines a display position of each of the objects on the display section, based on a position of each of the objects disposed in a predetermined depth space, to draw each of the objects at the determined display position; a depth selector which selects a depth selecting position indicating a position for defining the depth space along a depth axis, based on a depth selection command to be inputted from the user; and a display judger which judges whether each of the objects is located on a forward side or on a rearward side with respect to the depth selecting position in the depth space to extract only the objects located on the rearward side, as objects to be displayed. In this arrangement, the drawing section draws the objects to be displayed which have been extracted by the display judger.

An object selecting method according to yet another aspect of the invention is an object selecting method which allows a user to select from among a plurality of objects three-dimensionally displayed on a display section. The object selecting method includes a drawing step of causing a computer to determine a display position of each of the objects on the display section, based on a position of each of the objects disposed in a predetermined depth space, to draw each of the objects at the determined display position; a depth selecting step of causing the computer to select a depth selecting position indicating a position for defining the depth space along a depth axis, based on a depth selection command to be inputted from the user; and a display judging step of causing the computer to judge whether each of the objects is located on a forward side or on a rearward side with respect to the depth selecting position in the depth space to extract only the objects located on the rearward side, as objects to be displayed. In this arrangement, in the drawing step, the objects to be displayed which have been extracted in the display judging step are drawn.

### BRIEF DESCRIPTION OF DRAWINGS

FIG. 1 is a diagram showing an arrangement of an object selecting device embodying the invention.

FIG. 2 is a schematic diagram showing an example of a data structure of an object information database.

FIG. 3 is a diagram showing an example of a depth space to be generated by a display information extractor.

FIGS. 4A through 4C are diagrams showing examples of a display image to be displayed on a display in the embodiment, wherein FIG. 4A shows a display image displayed in a state that a video captured by a camera and tags are overlaid each other, FIG. 4B shows a display image to be displayed on the display, in the case where an intended tag is selected from among the tags shown in FIG. 4A, and FIG. 4C shows a modification example of the display image shown in FIG. 4A.

FIG. 5 shows an example of a display image in the embodiment.

FIG. 6 is a diagram showing a depth space in sliding a slide bar.

FIG. 7 is a diagram showing a display screen, in which a fine adjustment operation section is displayed.

FIG. 8A is a diagram showing a touch position by a user, and FIG. 8B is a screen diagram, in the case where plural correlated informations are displayed concurrently.

FIG. 9 is a diagram showing a small area to be defined in the depth space by a selector.

FIG. 10 is a flowchart showing a processing to be performed by the object selecting device in the embodiment until tags are displayed.

FIG. 11 is a flowchart showing a processing to be performed until correlated information corresponding to a tag selected by a user is displayed on the display.

FIGS. 12A and 12B are diagrams showing a display image, in which a select operation section is displayed.

FIG. 13 is a diagram showing a depth space, in the case where the select operation section shown in FIGS. 12A, 12B is used.

### DESCRIPTION OF EMBOD1MENTS

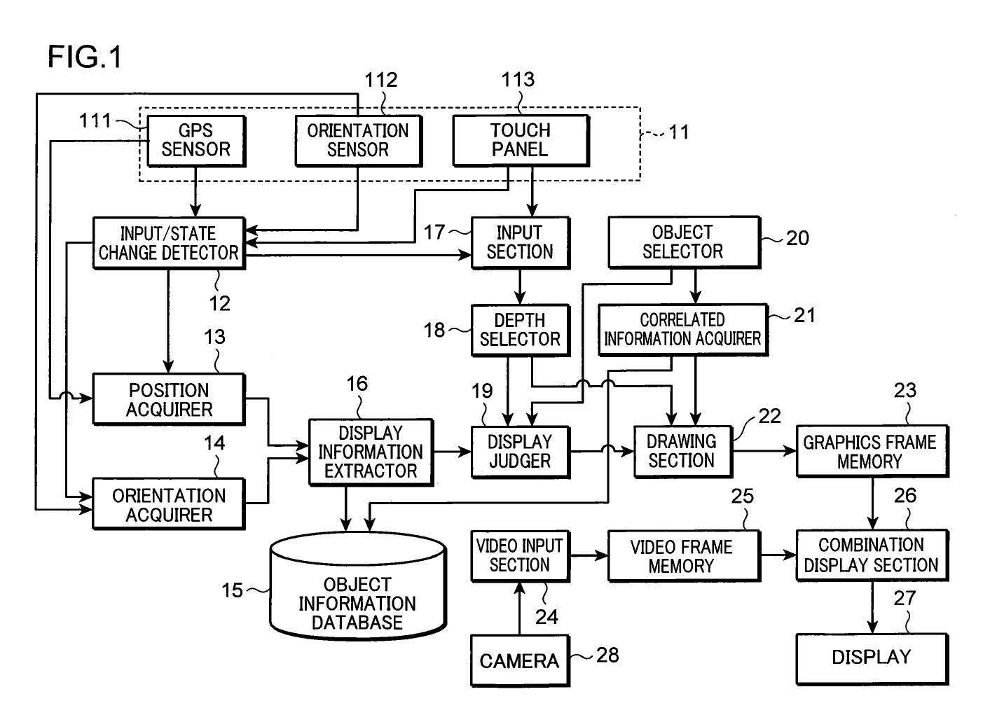

In the following, an object selecting device embodying the invention is described referring to the drawings. FIG. 1 is a diagram showing an arrangement of the object selecting device embodying the invention. In the following, there is described an example, wherein the object selecting device is applied to a mobile phone equipped with a touch panel, such as a smart phone.

The object selecting device is provided with a sensor section 11, an input/state change detector 12, a position acquirer 13, an orientation acquirer 14, an object information database 15, a display information extractor 16, an input section 17, a depth selector 18, a display judger 19, an object selector 20, a correlated information acquirer 21, a drawing section 22 a graphics frame memory 23, a video input section 24, a video frame memory 25, a combination display section 26, a display 27, and a camera 28.

Referring to FIG. 1, each of the blocks i.e. the input/state change detector 12 through the combination display section 26 is implemented by executing an object selecting program for causing a computer to function as an object selecting device. The object selecting program may be provided to the user by being stored in a computer-readable recording medium such as a DVD-ROM or a CD-ROM, or may be provided to the user by being downloaded from a server connected via a network.

The sensor section 11 is provided with a GPS sensor 111, an orientation sensor 112, and a touch panel 113. The GPS sensor 111 cyclically detects a current position of the object selecting device by acquiring navigation data to be transmitted from a GPS satellite for cyclically acquiring position information representing the detected current position. In this example, the position information includes e.g. a latitude and a longitude of the object selecting device.

The orientation sensor 112 is constituted of e.g. an electronic compass, and cyclically detects a current orientation of the object selecting device for cyclically acquiring orientation information representing the detected orientation. In this example, the orientation information may represent an orientation of the object selecting device with respect to a reference direction, assuming that a predetermined direction (e.g. a northward direction) displaced from a current position of the object selecting device is defined as the reference direction. The orientation of the object selecting device may be defined by e.g. an angle between the northward direction and a direction perpendicularly intersecting a display screen of the display 27.

The input/state change detector 12 detects an input of operation command by a user, or a change in the state of the object selecting device. Specifically, the input/state change detector 12 judges that the user has inputted an operation command in response to user's touching the touch panel 113, and outputs an operation command input notification to the input section 17.

Examples of the state change include a change in the position and a change in the orientation of the object selecting device. The input/state change detector 12 judges that the position of the object selecting device has changed in response to a change in the position information to be cyclically inputted from the GPS sensor 111, and outputs a state change notification to the position acquirer 13.

Further, the input/state change detector 12 judges that the orientation of the object selecting device has changed in response to a change in the orientation information to be cyclically outputted from the orientation sensor 112, and outputs a state change notification to the orientation acquirer 14.

The position acquirer 13 acquires position information detected by the GPS sensor 111. Specifically, the position acquirer 13 acquires position information detected by the GPS sensor 111 in response to an output of a state change notification from the input/state change detector 12, and holds the acquired position information. The position information to be held by the position acquirer 13 is successively updated, each time new position information is detected by the GPS sensor 111, as the user who carries the object selecting device moves from place to place.

The orientation acquirer 14 acquires orientation information detected by the orientation sensor 112. Specifically, the orientation acquirer 14 acquires orientation information detected by the orientation sensor 112 in response to an output of a state change notification from the input/state change detector 12, and holds the acquired orientation information. The orientation information to be held by the orientation acquirer 14 is successively updated, each time the orientation of the object selecting device changes, as the user who carries the object selecting device changes his or her orientation.

The object information database 15 is a database which holds information on real objects. In this example, the real objects are a variety of objects whose images are captured by the camera 28, and whose images are included in a video displayed on the display 27. The real objects correspond to e.g. a structure such as a building, shops in a building, and specific objects in a shop. The real objects, however, are not specifically limited to the above, and may include a variety of objects depending on the level of abstraction or the granularity of objects, e.g., the entirety of a town or a city.

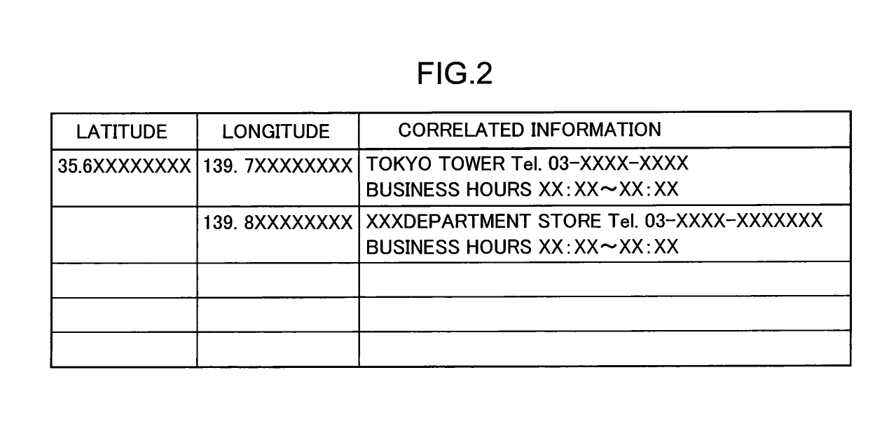

FIG. 2 is a schematic diagram showing an example of a data structure of the object information database 15. The object information database 15 is constituted of relational databases, in each of which one record is allocated to one real object, and e.g. includes fields on latitudes, longitudes, and correlated informations.

In other words, the object information database 15 stores latitudes, longitudes, and correlated informations in correlation with each other, for each of the real objects. In this example, the latitudes and the longitudes indicate latitudes and longitudes, as two-dimensional position information of the respective real objects on the earth, which are measured in advance. In the example shown in FIG. 2, since only the latitudes and the longitudes are included in the position information, each of the real objects is designated only at a two-dimensional position. Preferably, however, the object information database 15 may include heights representing the heights of the respective real objects from the ground, in addition to the latitudes and the longitudes. With the inclusion of the heights, it is possible to three-dimensionally specify the position of each of the real objects.

The correlated information is information for describing the contents of a real object. For instance, in the case where the real object is a shop, the correlated information on the real object corresponds to shop information such as the address and the telephone number of the shop, and coupons on the shop. Further, in the case where the real object is a shop, the correlated information may include buzz-marketing information representing e.g. the reputation on the shop.

Further, in the case where the real object is a building, the correlated information may include the construction date (year/month/day) of the building, and the name of the architect who built the building. Further, in the case where the real object is a building, the correlated information may include shop information about the shops in the building, and link information to the shop information. The object information database 15 may be held in advance in the object selecting device, or may be held on a server connected to the object selecting device via a network.

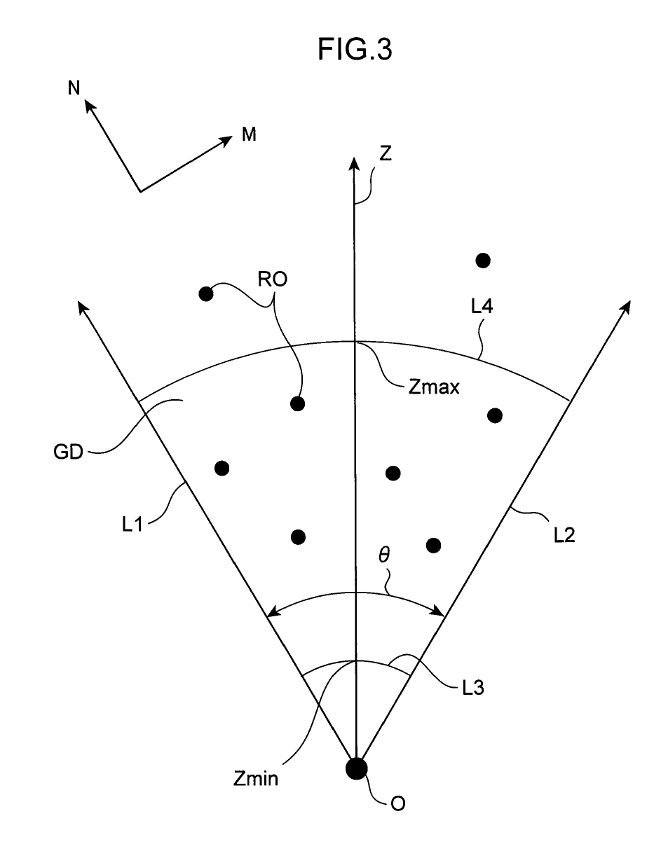

Referring back to FIG. 1, the display information extractor 16 generates a depth space shown in FIG. 3, based on latest position information acquired by the position acquirer 13 and latest orientation information acquired by the orientation acquirer 14; and extracts real objects RO to be displayed by plotting the real objects RO stored in the object information database 15 in the generated depth space.

FIG. 3 is a diagram showing an example of a depth space to be generated by the display information extractor 16. As shown in FIG. 3, the depth space is a two-dimensional space to be defined by a depth axis Z representing a depth direction of a display image to be displayed on the display 27.

The display information extractor 16 defines a depth space as follows. Firstly, in response to updating the current position information of the object selecting device by the position acquirer 13, the display information extractor 16 defines the latitude and the longitude as represented by the updated current position information as a current position O in a two-dimensional space. In this example, the two-dimensional space is e.g. a two-dimensional virtual space defined by two axes orthogonal to each other i.e. an M-axis corresponding to the latitude and an N-axis corresponding to the longitude. Further, the N-axis corresponds to the northward direction to be detected by the orientation sensor 112.

Next, the display information extractor 16 defines the depth axis Z in such a manner that the depth axis Z is aligned with an orientation as represented by the orientation information held by the orientation acquirer 14, using the current position O as a start point. For instance, assuming that the orientation information is θ1,which is angularly displaced clockwise from the northward direction, the depth axis Z is set at the angle of θ1 with respect to the N-axis. Hereinafter, the direction away from the current position O is called as a rearward side, and the direction toward the current position O is called as a forward side.

Next, the display information extractor 16 defines two orientation borderlines L1, L2 which pass the current position O in a state that a predetermined inner angle θ defined by the two orientation borderlines L1, L2 is halved by the depth axis Z. In this example, the inner angle θ is an angle set in advance in accordance with an imaging range of the camera 28, and is a horizontal angle of view of the camera 28.

Next, the display information extractor 16 plots, in the depth space, real objects located in an area surrounded by the orientation borderlines L1, L2, out of the real objects RO stored in the object information database 15. In this case, the display information extractor 16 extracts real objects located in the area surrounded by the orientation borderlines L1, L2, based on the latitudes and the longitudes of real objects stored in the object information database 15; and plots the extracted real objects in the depth space.

Alternatively, the real objects RO stored in the object information database 15 may be set in advance in a two-dimensional space. The modification is advantageous in omitting a processing of plotting the real objects RO by the display information extractor 16.

Next, the display information extractor 16 defines a near borderline L3 at a position away from the current position O by a distance Zmin. In this example, the near borderline L3 is a curve of a circle which is interposed between the orientation borderlines L1, L2, wherein the circle is defined by a radius Zmin and the current position O as a center.

Further, the display information extractor 16 defines a far borderline L4 at a position away from the current position O by a distance Zmax. In this example, the far borderline L4 is a curve of a circle which is interposed between the orientation borderlines L1, L2, wherein the circle is defined by a radius Zmax and the current position O as a center.

Real objects RO formed by plotting in a display area GD surrounded by the orientation borderlines L1, L2, the near borderline L3, and the far borderline L4 are displayed on the display 27 by tags T1.

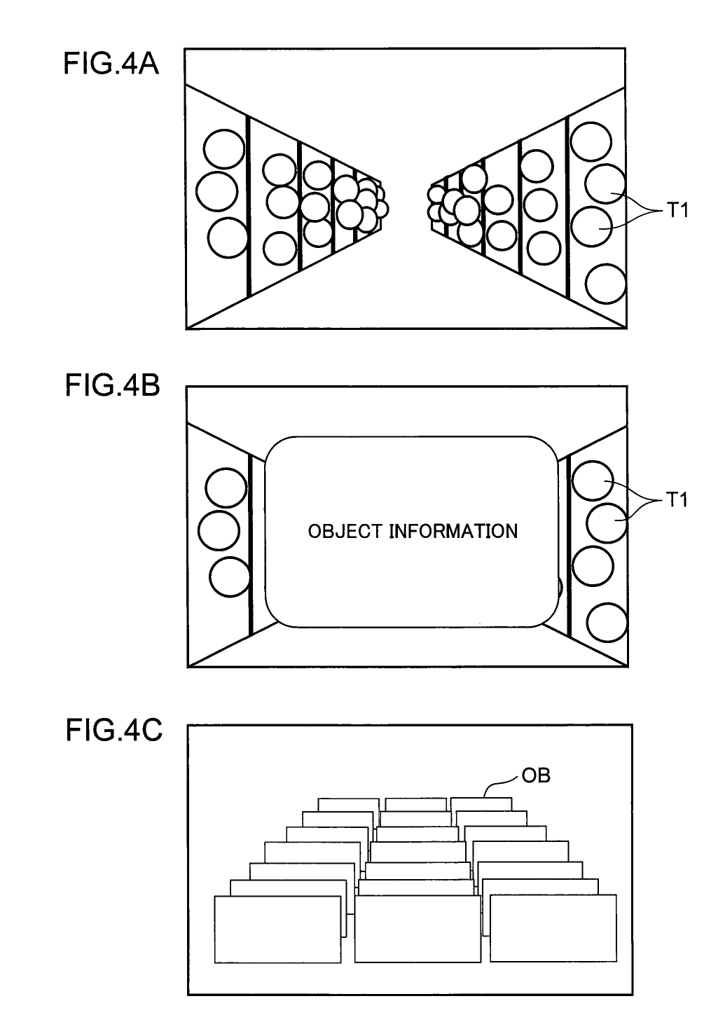

FIGS. 4A through 4C are diagrams showing examples of a display image to be displayed on the display 27 in this embodiment. FIG. 4A shows a display image displayed in a state that a video captured by the camera 28 and the tags T1 are overlaid each other, FIG. 4B shows a display image to be displayed on the display 27 in the case where an intended tag is selected from among the tags T1 shown in FIG. 4A, and FIG. 4C shows a modification of the display image shown in FIG. 4A. The diagram of FIG. 4C will be described later.

Each of the tags T1 shown in FIGS. 4A, 4B is a small circular image for notifying the user that a real object displayed behind other real object(s) includes additional information, and corresponds to an example of an object. The shape of the tag T1 is not limited to a circular shape, and includes various shapes such as a rectangular shape and a polygonal shape.

In response to user's selecting one tag T1 from among the tags T1 shown in FIG. 4A, as shown in FIG. 4B, the correlated information of the selected tag T1 is displayed on the display 27.

As shown in FIG. 3, if the tags T1 of real objects located at an infinite distance from the current position O are displayed on the display 27, the number of tags T1 to be displayed on the display 27 is enormous. Further, in this case, the tags T1 of real objects located so far that the user cannot visually perceive are also displayed. As a result, these tags T1 may become an obstacle in displaying the tags T1 which are located near the user and accordingly should be displayed.

In view of the above, in this embodiment, display of the tags T1 is restricted in such a manner that the tags T1 of real objects located farther from the far borderline L4 with respect to the current position O are not displayed.

Further, in the case where the tags T1 of real objects extremely close to the current position O are displayed, these tags T1 may occupy the area for a display image and obstruct the display image. In view of the above, in this embodiment, display of the tags T1 is restricted in such a manner that the tags T1 of real objects located on the forward side of the near borderline L3 with respect to the current position O are not displayed.

Referring back to FIG. 1, in response to an output of an operation command input notification from the input/state change detector 12, the input section 17 acquires coordinate data of a position touched by the user on a display image. In this example, the coordinate data is two-dimensional coordinate data including a vertical coordinate and a horizontal coordinate of a display image.

Further, the input section 17 judges whether the operation command inputted by the user is a depth selection command for selecting a depth, or a tag selection command for selecting a tag T1, based on the acquired coordinate data.

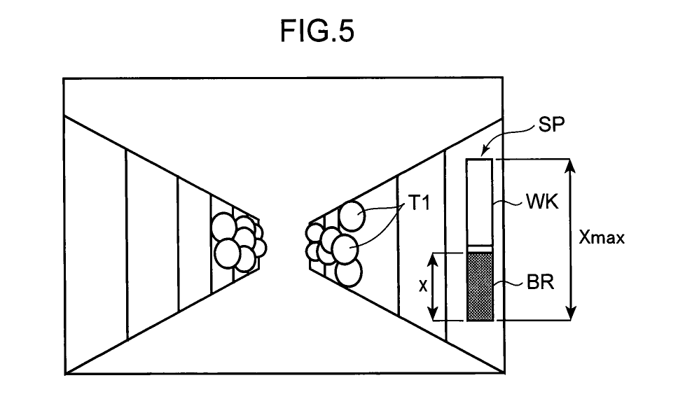

FIG. 5 is a diagram showing an example of a display image in the embodiment of the invention. In the example shown in FIG. 5, a slide operation section SP is displayed on the right side of the screen. The slide operation section SP includes a frame member WK, and a slide bar BR surrounded by the frame member WK. The user is allowed to input a depth selection command by sliding the slide bar BR.

With the above arrangement, in the case where the acquired coordinate data is located in the area of the slide bar BR, the input section 17 judges that the user has inputted a depth selection command. On the other hand, in the case where the acquired data is located in the area of one of the tags T1, the input section 17 judges that the user has inputted an object selection command.

As far as a tag T1 is located in a predetermined distance range from the position as represented by the acquired coordinate data, despite that the acquired coordinate data is not located in the area of any one of the tags T1, the input section 17 judges that the user has inputted an object selection command.

Then, in the case where it is judged that the user has inputted a depth selection command, the input section 17 specifies a change amount of the slide amount of the slide bar BR, based on the coordinate data obtained at the point of time when the user has started touching the touch panel 113 and the coordinate data obtained at the point of time when the user has finished the touching; specifies a slide amount (the total length is x) of the slide bar BR by adding a slide amount obtained at the point of time when the user has started touching the touch panel 113 to the specified change amount; and outputs the specified slide amount to the depth selector 18. On the other hand, in the case where it is judged that the user has inputted an object selection command, the input section 17 outputs the acquired coordinate data to the object selector 20.

In the example shown in FIG. 1, the touch panel 113 serves as an input device. Alternatively, any input device may be used, as far as the input device is a pointing device capable of designating a specific position of a display image, such as a mouse or an infrared pointer.

Further alternatively, the input device may be a member independently provided for the object selecting device, such as a remote controller for remotely controlling a television receiver.

The depth selector 18 selects a depth selecting position indicating a position along the depth axis Z, based on a depth selection command to be inputted by the user. Specifically, the depth selector 18 accepts a slide amount of the slide bar BR in the slide operation section SP to change the depth selecting position in cooperation with the slide amount.

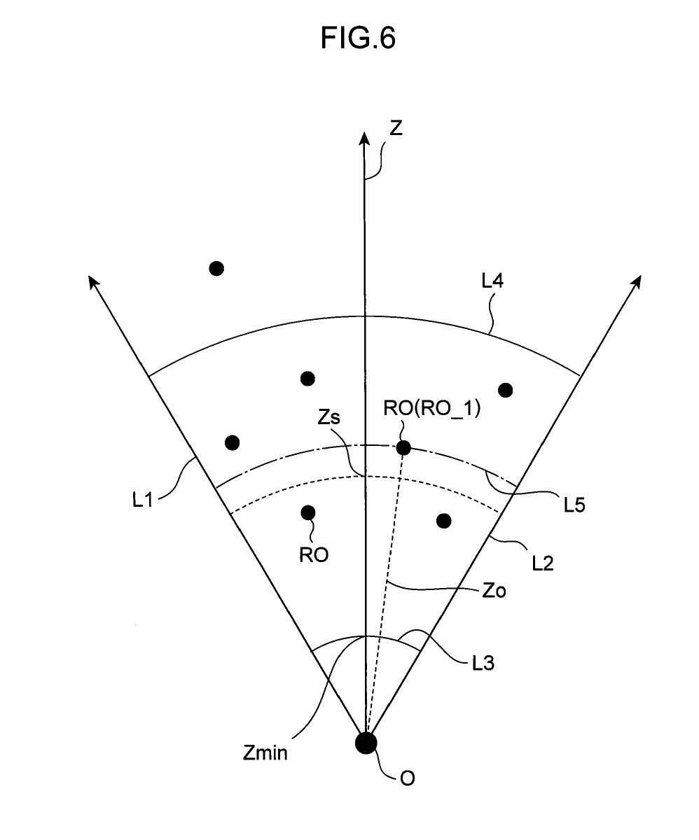

FIG. 6 is a diagram showing a depth space in sliding the slide bar BR. The depth selector 18 defines a depth selecting position Zs at a position on the depth axis Z shown in FIG. 6 in accordance with the total length x indicating the slide amount of the slide bar BR shown in FIG. 5. In other words, in the case where the total length x is zero, the depth selector 18 defines the depth selecting position Zs at the position away from the current position O by the distance Zmin i.e. at the near borderline L3. Further, the depth selector 18 moves the depth selecting position Zs toward the rearward side along the depth axis Z, as the total length x increases resulting from upward sliding of the slide bar BR. Further, the depth selector 18 defines the depth selecting position Zs at the position away from the current position by the distance Zmax i.e. at the far borderline L4, when the total length x of the slide bar BR is equal to Xmax.

Further, the depth selector 18 moves the depth selecting position Zs toward the forward side along the depth axis Z, as the total length x decreases resulting from downward sliding of the slide bar BR.

Specifically, the depth selector 18 calculates the depth selecting position Zs by the following equation (1).

Zs=(Zmax−Zmin)*((x/Xmax)²)+Zmin (1)

As shown in the equation (1), the term (x/Xmax) is raised to the second power. Accordingly, as the total length x of the slide bar BR increases, a change rate of the depth selecting position Zs with respect to a change rate of the total length x increases.

In the above arrangement, the shorter the total length x is, the higher the selecting resolution of the depth selecting position Zs is; and the longer the total length x is, the lower the selecting resolution of the depth selecting position Zs is. Thus, the user is allowed to precisely adjust between display and non-display of tags T1 on the forward side.

The depth selector 18 requests the drawing section 22 to update the display screen of the display 27 and to display the slide bar BR to be slidable, as the position of the slide bar BR is moved up and down by the user.

Alternatively, the depth selector 18 may be operated in such a manner that the total length x slides in response to user's manipulation of a fine adjustment operation section DP for finely adjusting the total length x of the slide bar BR to define the depth selecting position Zs in cooperation with the manipulation of the fine adjustment operation section DP.

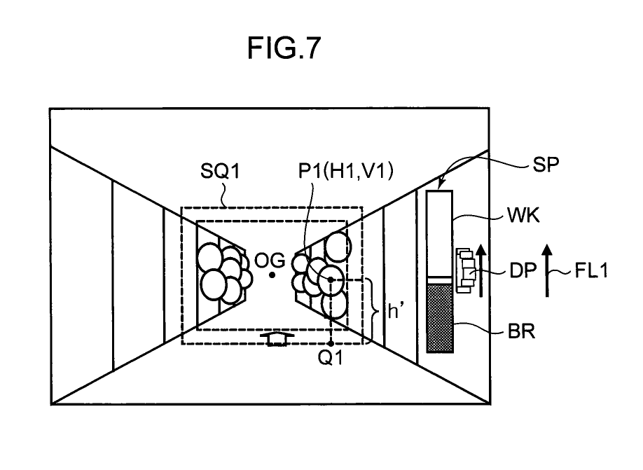

FIG. 7 is a diagram showing a display screen, in which the fine adjustment operation section DP is displayed. As shown in FIG. 7, the fine adjustment operation section DP is displayed on e.g. the right side of the slide operation section SP. The fine adjustment operation section DP is displayed in a display form mimicking a rotary dial, which is configured in such a manner that a part of the rotary dial is exposed from the surface of the display screen, and the rotary dial is rotated about an axis of rotation in parallel to the display screen.

In response to user's touching the display area of the fine adjustment operation section DP, and moving his or her fingertip upward or downward on the display area, the depth selector 18 discretely determines a rotation amount of the fine adjustment operation section DP in accordance with a moving amount FL1 of the fingertip, slides the total length x of the slide bar BR upward or downward by a change amount Δx corresponding to the determined rotation amount, and rotates and displays the fine adjustment operation section DP by the determined rotation amount.

In this example, the depth selector 18 displays the slide bar BR to be slidable in such a manner that a change amount Δx1 of the total length x with respect to a moving amount FL1 of the user's fingertip which touched the fine adjustment operation section DP is set smaller than a change amount Δx2 of the total length x with respect to a moving amount FL1 of the user's fingertip which directly manipulated the slide bar BR.

In other words, assuming that the moving amount of the fingertip is FL1, whereas the change amount Δxl of the total length x of the slide bar BR is e.g. FL1 in the case where the slide bar BR is directly manipulated, the change amount Δx2 is e.g. α·Δx1, where α is 0<α<1 in the case where the fine adjustment operation section DP is manipulated. In this embodiment, α is e.g. ⅕. Alternatively, a may be any value such as ⅓, ¼, ⅙.

The fine adjustment operation section DP is not necessarily a dial operation section, but may be constituted of a rotary member whose rotation amount is sequentially determined depending on the moving amount FL1 of the fingertip. The modification is more advantageous in finely adjusting the depth selecting position Zs by the user.

It is not easy for a user who is not familiar with manipulation on the touch panel 113 to directly manipulate the slide bar BR. In view of this, the fine adjustment operation section DP is provided so that the user is operable to slide the slide bar BR in cooperation with a rotating operation of the fine adjustment operation section DP.

Referring back to FIG. 1, the display judger 19 judges whether each of the real objects RO is located on the forward side or on the rearward side with respect to the depth selecting position Zs in the depth space, and extracts real objects RO located on the rearward side, as real objects RO to be displayed, in which the tags T1 are displayed.

With the above arrangement, as the slide bar BR shown in FIG. 7 slides upward by user's manipulation, or as the slide bar BR slides upward by upward rotation of the fine adjustment operation section DP, the tags T1 displayed on the forward side are successively brought to a non-display state, whereby the number of tags T1 to be displayed is decreased.

On the other hand, as the slide bar BR slides vertically downward, or as the slide bar BR slides downward by downward rotation of the fine adjustment operation section DP, the number of tags T1 to be displayed is successively increased from the rearward side toward the forward side.

As a result of the above operation, the tags T1 that have not been displayed or the tags T1 that have not been greatly exposed, because of the existence of the tags T1 on the forward side, are greatly exposed. Thus, the user is allowed to easily select from among these tags T1.

In this example, the display judger 19 may cause the drawing section 22 to perform a drawing operation in such a manner that the tags T1 of real objects RO which are located on the forward side with respect to the depth selecting position Zs shown in FIG. 6, and which are located in the area surrounded by the orientation borderlines L1, L2 are displayed in a semi-translucent manner. In the modification, the drawing section 22 may combine the tags T1 and video data captured by the camera 28 with a predetermined transmittance by e.g. an alpha-blending process.

Referring back to FIG. 1, in response to a judgment that an object selection command has been inputted by the input section 17, and in response to an output of coordinate data on the touch position, the object selector 20 specifies the tag T1 selected by the user from among the tags T1 to be displayed.

In the case where the touch panel 113 is used as the input device, a touch position recognized by the user may be displaced from a touch position recognized by the input device. Accordingly, in the case where plural tags T1 are displayed near the touch position, there is a case that a tag T1 different from the tag T1 which the user intends to select may be selected.

The object selecting device in this embodiment is operable to bring the tags T1, displayed on the forward side with respect to the tag T1 which the user intends to select, to a non-display state. Accordingly, it is highly likely that the tag T1 which the user intends to select may be displayed at a forward-most position among the tags T1 displayed in the vicinity of the touch position.

In view of the above, the object selector 20 specifies the tag T1 which is displayed at a forward-most position in a predetermined distance range from the touch position, as the tag T1 selected by the user.

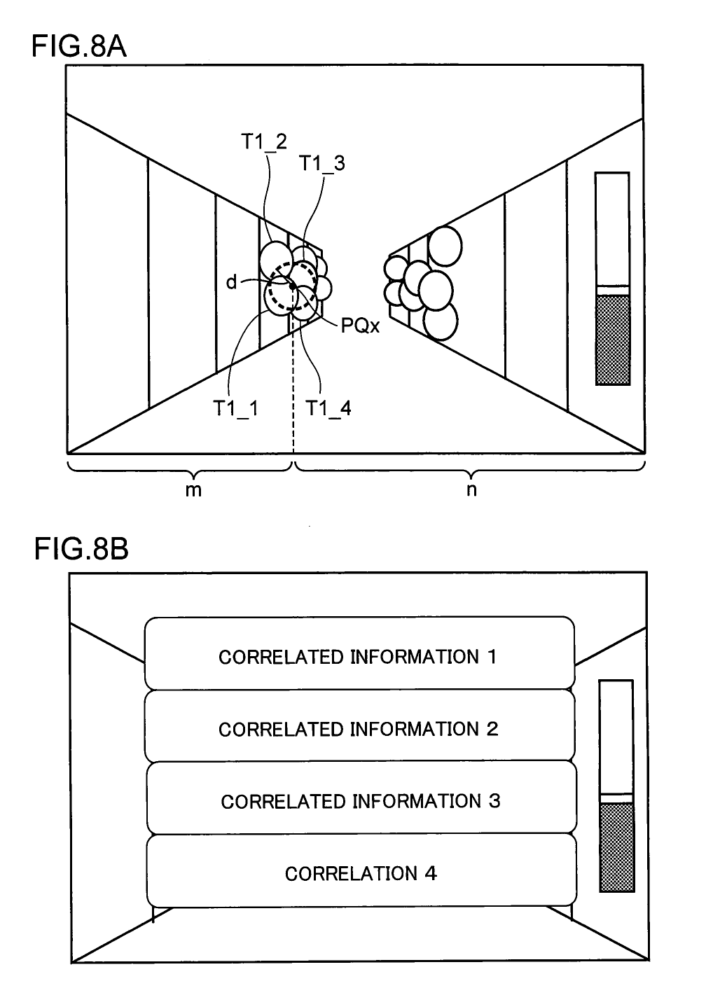

FIG. 8A is a diagram showing a touch position by the user, and FIG. 8B is a screen diagram in the case where plural correlated informations are concurrently displayed. In FIG. 8A, PQx indicates a touch position touched by the user. In this case, the object selector 20 specifies a forward-most located tag T1_1, out of the tag T1_1, a tag T1_2, a tag T1_3, and a tag T1_4 which are located in a range away from the touch position PQx by a predetermined distance d, as the tag selected by the user. In this example, the object selector 20 may specify a tag T1, whose distance between a position of the real object RO corresponding to each one of the tags T1_1 through T1_4 in the depth space, and the current position O is shortest, as the forward-most located tag T1.

As described above, the object selector 20 basically specifies the forward-most located tag T1, out of the tags T1 in the range away from the touch position by the predetermined distance d, as the tag T1 selected by the user. However, in the case where plural tags T1 are displayed in the vicinity of a tag T1 selected by the user, the user may have difficulty in deciding which position the user should touch to select an intended tag T1.

In view of the above, the object selector 20 sets a small area RD at a position corresponding to a touch position in the depth space, and causes the display 27 to display correlated informations of all the real objects RO located in the small area RD.

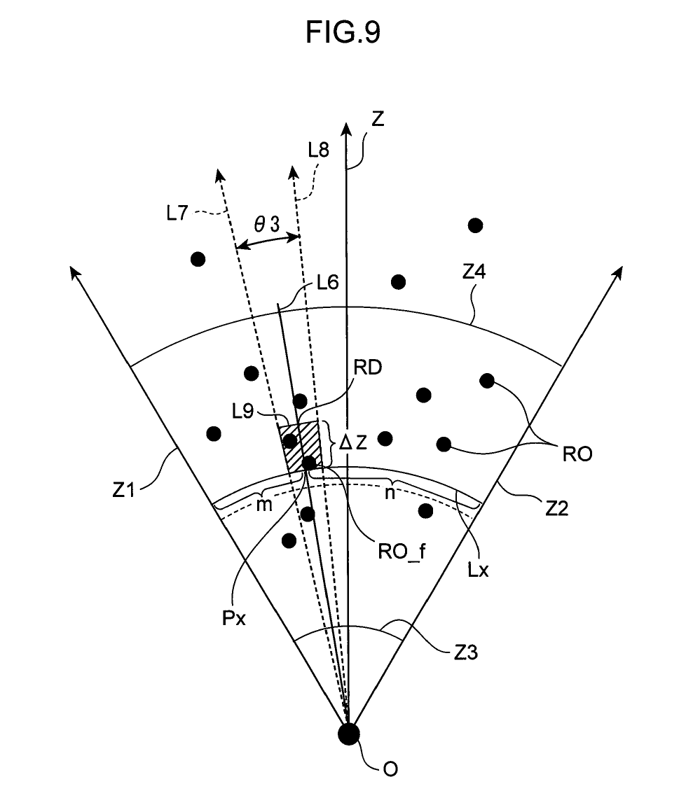

FIG. 9 is a diagram showing the small area RD to be defined in the depth space by the object selector 20. Firstly, the object selector 20 specifies a position of a real object RO corresponding to a tag T1 which has been judged to be located at a forward-most position in the depth space. In FIG. 9, let it be assumed that a real object RO_f is the real object RO corresponding to the tag T1 which has been judged to be located at a forward-most position in the small area RD. Then, as shown in FIG. 8A, the object selector 20 obtains an internal division ratio (m:n), with which the touch position PQx internally divides a lower side of a display image from a left end thereof. Then, the object selector 20 defines, in the depth space shown in FIG. 9, a circle whose radius is equal to a distance between the position of the real object RO _f and the current position O, and whose center is aligned with the current position O, as an equidistant curve Lx.

Then, a point at which the equidistant curve Lx is internally divided with respect to an orientation borderline Z1 is obtained as a position Px corresponding to the touch position PQx in the depth space.

Then, a straight line L6 passing the current position O and the position Px is defined. Then, there are defined two straight lines L7, L8 which pass the current position O in such a manner that a predetermined angle θ3 is halved by the straight line L6. Then, there is defined a circle whose radius is equal to the distance between a position displaced rearward with respect to the position Px along the straight line L6 by Δz, and the current position O, and whose center is aligned with the current position O, as an equidistant curve L9. In this way, an area surrounded by the equidistant curves Lx, L9, and the straight lines L7, L8 is defined as the small area RD.

The angle θ3 and the value Δz may be set in advance, based on a displacement between a touch position which is presumably recognized by the user, and a touch position recognized by the touch panel 113.

In response to receiving a notification of real objects RO included in the small area RD from the object selector 20, the correlated information acquirer 21 extracts the correlated informations on the notified real objects RO from the object information database 15, and causes the drawing section 22 to draw the extracted correlated informations.

By performing the above operation, a display image as shown in FIG. 8B is displayed on the display 27. In the example shown in FIG. 8B, correlated informations on four real objects RO are displayed, because the four real objects RO are included in the small area RD.

In this example, referring to FIG. 8B, only a part of informations such as the names of the real objects RO is displayed, out of the correlated informations stored in the object information database 15 as correlated informations to be displayed. Then, in response to user's touching the touch panel 113 and selecting one of the real objects RO, the detailed correlation information on the selected real object RO may be displayed. The above arrangement is advantageous in saving the display space in displaying plural correlated informations at once, and in displaying a larger amount of correlated informations. In the case where it is impossible to display correlated informations to be displayed at once on the display area of the display 27 at once, the correlated informations may be scroll-displayed.

Referring back to FIG. 1, the correlated information acquirer 21 extracts, from the object information database 15, the correlated information of a tag T1 which has been judged to be selected by the user by the object selector 20, and causes the drawing section 22 to display the extracted correlated information. As described above, in the case where plural real objects RO are included in the small area RD, the correlated information acquirer 21 extracts the correlated informations of the real objects RO from the object information database 15, and causes the drawing section 22 to display the extracted correlated informations.

The drawing section 22 determines, in a display image, display positions of real objects RO to be displayed which have been extracted by the display judger 19 to draw the tags T1 at the determined display positions.

In this example, the drawing section 22 may determine, in the depth space, display positions of the tags T1, based on a positional relationship between the current position O and the positions of the respective real objects RO to be displayed. Specifically, the display positions may be determined as follows.

Firstly, as shown in FIG. 6, there is defined a curve of a circle whose center is aligned with the current position O, which passes the real object RO_1, and which is surrounded by the orientation borderlines L1, L2, as an equidistant curve L5. Then, a distance Zo between the current position O and the position of the real object RO_1 is obtained.

Then, as shown in FIG. 7, a rectangular area SQ1 corresponding to the distance Zo is defined in a display image. In this example, the rectangular area SQ1 has a shape whose center is aligned with e.g. a center OG of a display image, and whose shape is similar to the shape of the display image. The size of the rectangular area SQ1 is a size reduced at a predetermined reduction scale depending on the distance Zo. In this example, the relationship between the reduction scale and the distance Zo is defined in such a manner that as the distance Zo increases, the reduction scale increases, and as the distance Zo decreases, the reduction scale decreases, and that the reduction scale is set to one when the distance Zo is zero.

Next, an internal division ratio with which the real object RO_1 shown in FIG. 6 internally divides the equidistant curve L5 is obtained. In this example, the real object RO_1 internally divides the equidistant curve L5 with a ratio (m:n) with respect to the orientation borderline L1.

Then, there is obtained a point Q1 which internally divides the lower side of the display image shown in FIG. 7 with a ratio (m:n), and a horizontal coordinate of the point Q1 in the display image is obtained as a horizontal coordinate H1 of a display position P1 of the tag T1 of the real object RO_1.

Then, in the case where a height h of the real object RO_1 is stored in the object information database 15, a height h′ is obtained by reducing the height h at a reduction scale depending on the distance Zo, and a vertical coordinate of a display image vertically displaced from the lower side of the rectangular area SQ1 by the height h′ is defined as a vertical coordinate V1 of the display position P1. In the case where the height of the real object RO_1 is not stored, a tag T1 may be displayed at an appropriate position on a vertical straight line which passes the coordinate H1.

Next, the area of the tag T1 is reduced at a reduction scale depending on the distance Zo, and the reduced tag T1 is displayed at the display position P1. The depth selector 18 performs the aforementioned processing to the tags T1 for each of the real objects RO to be displayed to determine the display positions of the tags T1.

Referring back to FIG. 1, the drawing section 22 draws the slide operation section SP and the fine adjustment operation section DP in the graphics frame memory 23 in accordance with a drawing request from the depth selector 18. Further, the drawing section 22 draws the correlated information in the graphics frame memory 23 in accordance with a drawing request from the correlated information acquirer 21.

The graphics frame memory 23 is a memory which holds image data drawn by the drawing section 22. The video input section 24 acquires video data of the real world captured at a predetermined frame rate by the camera 28, and successively writes the acquired video data into the video frame memory 25. The video frame memory 25 is a memory which temporarily holds video data outputted at a predetermined frame rate from the video input section 24.

The combination display section 26 overlays video data held in the video frame memory 25 and image data held in the graphics frame memory 23, and generates a display image to be actually displayed on the display 27. In this example, the combination display section 26 overlays the image data held in the graphics frame memory 23 at a position on a forward side with respect to the video data held in the video frame memory 25. With this arrangement, the tags T1, the slide operation section SP, and the fine adjustment operation section DP are displayed on a forward side with respect to the real world video. The display 27 is constituted of e.g. a liquid crystal panel or an organic EL panel constructed in such a manner that the touch panel 113 is attached to a surface of a base member, and displays a display image obtained by combining the image data and the video data by the combination display section 26. The camera 28 acquires video data of the real world at a predetermined frame rate, and outputs the acquired video data to the video input section 24.

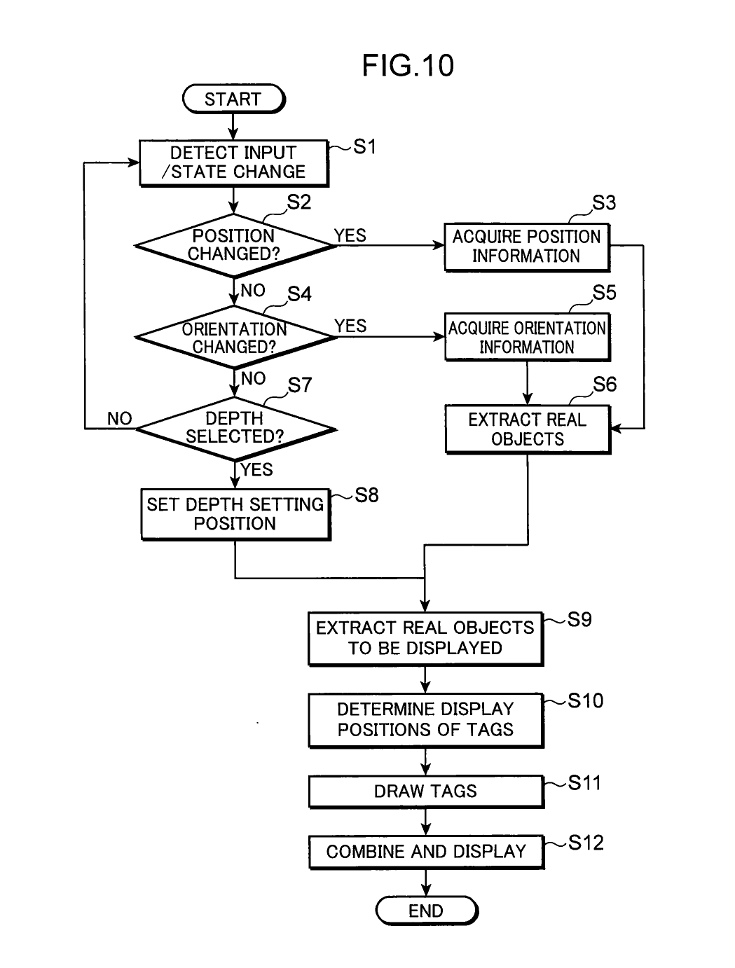

FIG. 10 is a flowchart showing a processing to be performed until the object selecting device displays the tags T1 in the embodiment. Firstly, the input/state change detector 12 detects an input of operation command by the user, or a change in the state of the object selecting device (Step S1). In this example, the input of operation command indicates that the user has touched the touch panel 113, and the change in the state includes a change in the position and a change in the orientation of the object selecting device.

Then, in the case where the input/state change detector 12 detects a change in the position of the object selecting device (YES in Step S2), the position acquirer 13 acquires position information from the GPS sensor 111 (Step S3).

On the other hand, in the case where the input/state change detector 12 detects a change in the orientation of the object selecting device (NO in Step S2 and YES in Step S4), the orientation acquirer 14 acquires orientation information from the orientation sensor 112 (Step S5).

Then, the display information extractor 16 generates a depth space, using the latest position information and the latest orientation information of the objet selecting device, and extracts real objects RO located in the display area GD, as real objects RO to be displayed (Step S6).

On the other hand, in the case where the input section 17 judges that the user has inputted a depth selection command (NO in Step S4 and YES in Step S7), the depth selector 18 defines a depth selecting position Zs from the entire length x of the slide bar BR manipulated by the user (Step S8).

Then, the display judger 19 extracts real objects RO located on a rearward side with respect to the depth selecting position Zs defined by the depth selector 18, from among the real objects RO to be displayed, which have been extracted by the display information extractor 16, as real objects RO to be displayed (Step S9).

Then, the drawing section 22 determines the display positions of tags T1 in the depth space, based on the positional relationship between the current position O and the positions of the respective real objects RO (Step S10).

Then, the drawing section 22 draws the tags T1 of the real objects RO to be displayed at the determined display positions (Step S 11). Then, the combination display section 26 combines the image data held in the graphics frame memory 23 and the video data held in the video frame memory 25 in such a manner that the image data is overlaid on the video data for generating a display image, and displays the generated display image on the display 27 (Step S12).

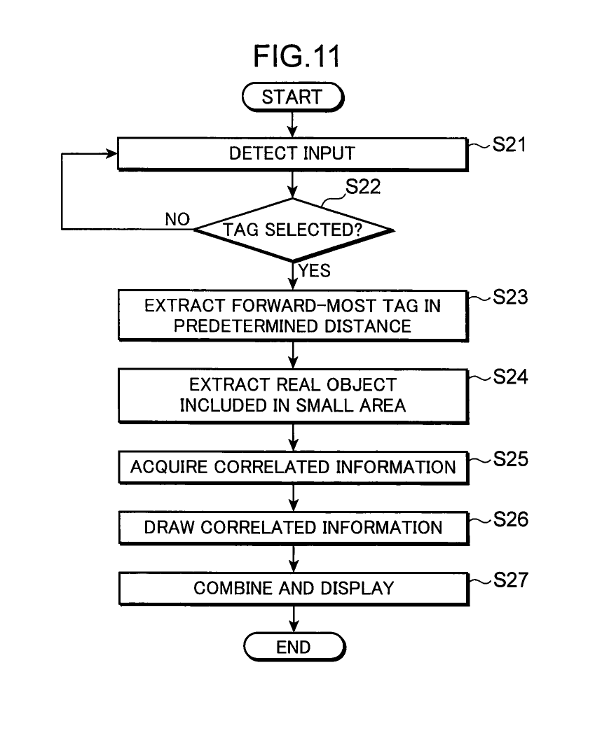

FIG. 11 is a flowchart showing a processing to be performed until the correlated information corresponding to the tag T1 selected by the user is displayed on the display 27.

Firstly, the input/state change detector 12 detects that the user has inputted an operation command (Step S21). Then, in the case where the input section 17 judges that the operation command from the user is a tag selection command (YES in Step S22), as shown in FIG. 8A, the object selector 20 extracts a tag T1_1 located at a forward-most position, from among the tags located in a range away from the touch position PQx by the distance d (Step S23).

On the other hand, in the case where the input section 17 judges that the operation command from the user is not a tag selection command (NO in Step S22), the routine returns the processing to Step S21.

Then, as shown in FIG. 9, the object selector 20 sets the small area RD at a position of the real object RO_f corresponding to the tag T1_1 in the depth space, and extracts a real object RO included in the small area RD (Step S24).

Then, the correlated information acquirer 21 acquires the correlated information of the extracted real object RO from the object information database 15 (Step S25). Then, the drawing section 22 draws the correlated information acquired by the correlated information acquirer 21 in the graphics frame memory 23 (Step S26).

In performing the above operation, in the case where the object selector 20 extracts plural real objects RO, the correlated informations of the real objects RO are drawn as shown in FIG. 8B.

Then, the combination display section 26 combines the image data held in the graphics frame memory 23 and the video data held in the video frame memory 25 in such a manner that the image data is displayed over the video data, and displays the combined data on the display 27 (Step S27).

In the case where the object selector 20 extracts plural real objects RO, it is possible to display, on the display 27, only the correlated information of the real object RO which is located closest to the depth selecting position Zs defined by the depth selector 18.

Further alternatively, it is possible to display, on the display 27, an image to be used in allowing the user to select one correlated information from among the plural correlated informations shown in FIG. 8B, and to cause the display 27 to display the one correlated information selected by the user.

Further alternatively, in displaying the correlated information, the combination display section 26 may generate a display image based only on the image data held in the graphics frame memory 23, without combining the image data and the video data held in the video frame memory 25, for displaying the generated display image on the display 27.

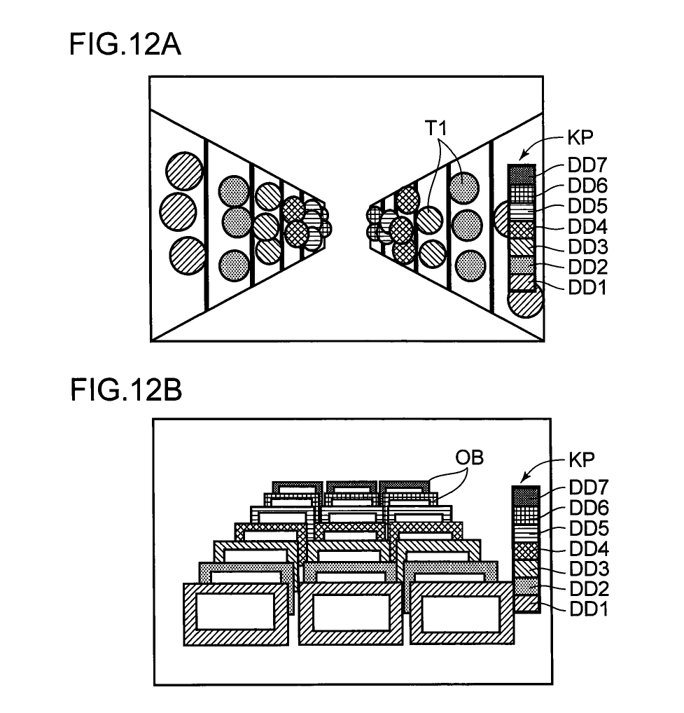

Further, in the foregoing description, as shown in FIG. 7, the user is allowed to select the depth selecting position Zs, using the slide bar BR. The invention is not limited to the above. The user may be allowed to select the depth selecting position Zs, using a select operation section KP shown in FIGS. 12A, 12B.

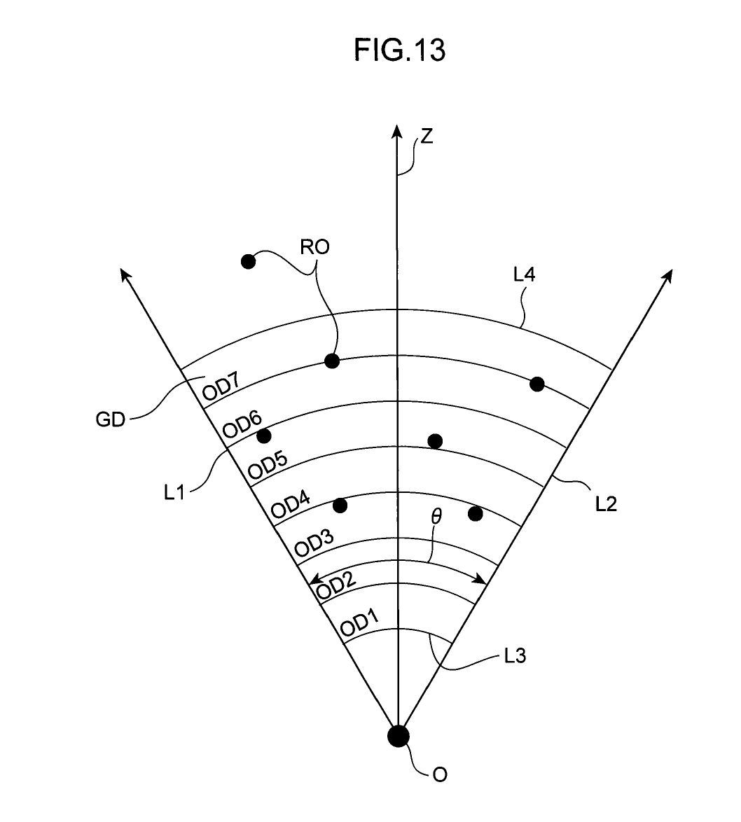

FIGS. 12A, 12B are diagrams showing a display image, in which the select operation section KP is displayed. In the case where the select operation section KP is displayed, a depth space is divided into plural depth regions along a depth axis Z. FIG. 13 is a diagram showing a depth space, in the case where the select operation section KP shown in FIGS. 12A, 12B is displayed.

As shown in FIG. 13, the depth space is divided into seven depth regions OD1 through OD7 along the depth axis Z. Specifically, the seven depth regions OD1 through OD7 are defined by concentrically dividing a display area GD into seven regions with respect to a current position O as a center. In this example, the depthwise sizes of the depth regions OD1 through OD7 may be reduced, as the depth regions OD1 through OD7 are away from the current position O, or may be set equal to each other.

As shown in FIG. 12A, the select operation section KP includes plural selection segments DD1 through DD7 which are correlated to the depth regions OD1 through OD7, and are arranged in a certain order with different colors from each other. In this example, there are provided seven depth regions OD1 through OD7. Accordingly, there are formed seven selection segments DD1 through DD7.

The user is allowed to select one of the selection segments DD1 through DD7, and to input a depth operation command by touching the touch panel 113. Hereinafter, the depth regions OD1 through OD7 are generically called as depth regions OD unless the depth regions OD1 through OD7 are discriminated, and the selection segments DD1 through DD7 are generically called as selection segments DD unless the selection segments DD1 through DD7 are discriminated. Further, the number of the depth regions OD and the number of the selection segments DD are not limited to seven, but an appropriate number e.g. two or more but not exceeding six, or eight or more may be used.

A drawing section 22 draws a tag T1 of each of the real objects RO, while attaching, to each of the real objects RO, the same color as the color of the selection segment DD correlated to the depth region OD to which each of the real objects RO belongs.

For instance, let it be assumed that first through seventh colors are attached to the selection segments DD1 through DD7. Then, the drawing section 22 attaches the first through seventh colors to each of the tags T1 in such a manner that the first color is attached to the tags T1 of real objects RO located in the depth region OD1, and that the second color is attached to the tags T1 of real objects RO located in the depth region OD2.

Then, upon user's touching e.g. the selection segment DD3, a depth selector 18 selects a position on a forward-side borderline of the depth region OD3 correlated to the selection segment DD3 with respect to the depth axis Z, as a depth selecting position Zs.

Then, a display judger 19 extracts real objects RO located on a rearward side with respect to the depth selecting position Zs, as real objects RO to be displayed, and causes the drawing section 22 to draw the tags T1 of the extracted real objects RO. With this arrangement, in the case where the selection segment DD3 is touched by the user, in FIG. 12A, the tags T1 displayed with the first color and the tags T1 displayed with the second color are brought to a non-display state, and only the tags T1 displayed with the third through seventh colors are displayed.

The first through seventh colors may preferably be graded colors expressed in such a manner that the colors gradually change, as the colors change from the first color to the seventh color.

In the foregoing description, tags T1 are overlaid on real objects RO included in video data captured by the camera 28. The invention is not limited to the above. For instance, the invention may be applied to a computer or a graphical user interface of an AV apparatus configured in such a manner that icons or folders are three-dimensionally displayed.

In the above modification, objects constituted of icons or folders may be handled in the same manner as the real objects RO as described above, and as shown in FIG. 4C, objects OB may be three-dimensionally displayed, in place of the tags T1. In the example of FIG. 4C, it is clear that the objects OB are three-dimensionally displayed, because the areas of the objects OB gradually decrease from the objects OB on a forward side toward the objects OB on a rearward side.

In the above modification, the position of each of the objects OB may be plotted in the depth space; and in response to setting a depth selecting position Zs in accordance with a slide amount of the slide bar BR, the display judger 19 may extract objects OB on a rearward side with respect to the depth selecting position Zs, as objects OB to be displayed, and may cause the drawing section 22 to draw the extracted objects OB to be displayed.

Further, as shown in FIG. 12B, each of the objects OB may be displayed with use of a color corresponding to the depth region OD to which each of the objects OB belongs in the same manner as described referring to FIG. 12A. In this modification, in response to user's touching one of the selection segments DD in the select operation section KP, a position on a forward-side borderline of the depth region OD corresponding to the touched selection segment DD with respect to the depth axis Z may be set as a depth selecting position Zs, and the display judger 19 may extract objects OB located on a rearward side with respect to the depth selecting position Zs, as objects OB to be displayed, and may cause the drawing section 22 to draw the extracted objects OB to be displayed.

Further alternatively, the depth select operation section KP shown in FIGS. 12A, 12B may be provided with a slide bar BR. In this modification, in response to user's positioning a lead end of the slide bar BR to an intended selection segment DD, tags T1 or objects OB on a rearward side with respect to the depth region OD corresponding to the positioned selection segment DD are drawn on the display 27.

Further, in the foregoing description, the object selecting device is constituted of a smart phone. The invention is not limited to the above, and the invention may be applied to a head mounted display.

Further, in the foregoing description, the slide operation section SP, the select operation section KP, and the fine adjustment operation section DP are displayed on the display 27. The invention is not limited to the above, and these elements may be configured as a physical input device.

Further, in the foregoing description, the slide operation section SP, the select operation section KP, and the fine adjustment operation section DP are displayed on the display 27. The invention is not limited to the above. In the case where the object selecting device is a mobile terminal equipped with e.g. a function of an acceleration sensor of detecting an inclination of the object selecting device itself, a depth selection command may be executed based on a direction representing a change in the inclination and an amount of a change in the inclination of the terminal. For instance, inclining the mobile terminal in a forward direction or in a rearward direction corresponds to sliding the slide bar BR in the slide operation section SP upward or downward, and the amount of a change in the inclination corresponds to a slide amount of the slide bar BR.

The following is a summary of the technical features of the invention.

(1) An object selecting device according to an aspect of the invention is an object selecting device which allows a user to select from among a plurality of objects three-dimensionally displayed on a display section. The object selecting device includes a drawing section which determines a display position of each of the objects on the display section, based on a position of each of the objects disposed in a predetermined depth space, to draw each of the objects at the determined display position; a depth selector which selects a depth selecting position indicating a position for defining the depth space along a depth axis, based on a depth selection command to be inputted from the user; and a display judger which judges whether each of the objects is located on a forward side or on a rearward side with respect to the depth selecting position in the depth space to extract only the objects located on the rearward side, as objects to be displayed. In this arrangement, the drawing section draws the objects to be displayed which have been extracted by the display judger.

An object selecting program according to another aspect of the invention is an object selecting program which causes a computer to function as an object selecting device which allows a user to select from among a plurality of objects three-dimensionally displayed on a display section. The object selecting device includes a drawing section which determines a display position of each of the objects on the display section, based on a position of each of the objects disposed in a predetermined depth space, to draw each of the objects at the determined display position; a depth selector which selects a depth selecting position indicating a position for defining the depth space along a depth axis, based on a depth selection command to be inputted from the user; and a display judger which judges whether each of the objects is located on a forward side or on a rearward side with respect to the depth selecting position in the depth space to extract only the objects located on the rearward side, as objects to be displayed. In this arrangement, the drawing section draws the objects to be displayed which have been extracted by the display judger.

An object selecting method according to yet another aspect of the invention is an object selecting method which allows a user to select from among a plurality of objects three dimensionally displayed on a display section. The object selecting method includes a drawing step of causing a computer to determine a display position of each of the objects on the display section, based on a position of each of the objects disposed in a predetermined depth space, to draw each of the objects at the determined display position; a depth selecting step of causing the computer to select a depth selecting position indicating a position for defining the depth space along a depth axis, based on a depth selection command to be inputted from the user; and a display judging step of causing the computer to judge whether each of the objects is located on a forward side or on a rearward side with respect to the depth selecting position in the depth space to extract only the objects located on the rearward side, as objects to be displayed. In this arrangement, in the drawing step, the objects to be displayed which have been extracted in the display judging step are drawn.

In these arrangements, each of the objects is disposed in a depth space defined by a depth axis representing a depth direction of a display image. Each of the objects is drawn at a display position on the display image corresponding to the position of each of the objects disposed in the depth space, and is three-dimensionally displayed on the display image.

In response to user's input of a depth selection command, a depth selecting position is selected based on the depth selection command. It is judged whether each of the objects is located on a forward side or on a rearward side with respect to the depth selecting position, and only the objects located on the rearward side are drawn on the display image.

In other words, in response to user's selecting a depth selecting position, the objects located on a forward side with respect to the depth selecting position can be brought to a non-display state. Accordingly, the objects which have been hardly displayed or have been completely concealed due to the existence of the forwardly-located objects in the conventional art, are greatly exposed, because the forwardly-located objects are brought to a non-display state. This allows the user to easily and speedily select from among the objects to be displayed.

(2) In the above arrangement, preferably, the object selecting device may further include a slide operation section which is slid in a predetermined direction in response to user's manipulation, wherein the depth selector accepts a slide amount of the slide operation section as the depth selection command to change the depth selecting position in association with the slide amount.

In the above arrangement, as the user increases the slide amount of the slide operation section, the forward-located objects are brought to a non-display state one after another in association with the increase of the slide amount. This allows the user to select the objects which should be brought to be a non-display state with simplified manipulation.

(3) In the above arrangement, preferably, the object selecting device may further include a fine adjustment operation section which finely adjusts the slide amount of the slide operation section in response to user's manipulation, wherein the slide amount is set in such a manner that a change amount to be displayed on the display section in the case where the fine adjustment section is manipulated by the user is smaller than a change amount to be displayed on the display section in the case where the slide operation section is manipulated by the user.

In the above arrangement, since the user can finely adjust the slide amount of the slide operation section, the slide amount of the slide operation section can be more accurately adjusted. This allows the user to securely expose an intended object, and to securely select the intended object. Further, the user is allowed to directly manipulate the slide operation section to roughly adjust the slide amount of the slide operation section, and thereafter, is allowed to finely adjust the slide amount of the slide operation section with use of the fine adjustment operation section. This allows the user to adjust the slide amount speedily and accurately. Further, even a user who is not familiar with manipulation of the slide operation section can easily adjust the slide amount of the slide operation section to an intended slide amount by manipulating the fine adjustment operation section.

(4) In the above arrangement, preferably, the fine adjustment operation section may be constituted of a rotary dial, and the depth selector may change the depth selecting position in cooperation with the slide amount of the slide operation section which is slid by rotating the rotary dial.

In the above arrangement, the user is allowed to bring the obstacle objects to a non-display state by cooperation with manipulation of the rotary dial.

(5) In the above arrangement, preferably, the depth selector may increase a change rate of the depth selecting position with respect to a change rate of the slide amount, as the slide amount increases.

In the above arrangement, adjustment between display and non-display of objects of interest to the user can be precisely performed.

(6) In the above arrangement, preferably, the depth space may be divided into a plurality of depth regions along the depth axis, the object selecting device may further include a select operation section which includes a plurality of selection segments correlated to the respective depth regions and arranged in a certain order with different colors from each other, the select operation section being operable to accept the depth selection command, the drawing section may draw each of the objects, while attaching the same color as the color of the selection segment correlated to the depth region to which each of the objects belongs, and the depth selector may select a position on a forward-side borderline of the depth region correlated to the selection segment selected by the user with respect to the depth axis, as the depth selecting position.

In the above arrangement, in response to user's selecting a selection segment of the same color as the color attached to an intended object, the objects of the different colors which are displayed on a forward side with respect to the intended object are brought to a non-display state. This allows the user to easily expose an intended object, using the colors as an index.

(7) In the above arrangement, preferably, the display section may be constituted of a touch panel, and the object selecting device may further include an object selector which selects a forwardmost-displayed object, out of the objects to be displayed which are located in a predetermined area away from a touch position on a display image touched by the user.

It is expected that the user may adjust the depth selecting position in such a manner that an intended object is displayed at a forwardmost position on the display image. The above arrangement allows the user to select an intended object, even if the touch position is displaced from the position of the intended object.

(8) In the above arrangement, preferably, the object selector may extract the objects to be displayed, as candidate select objects, the objects to be displayed being located in a predetermined distance range away from a position in the depth space corresponding to the touch position.

In the above arrangement, in the case where there exist multitudes of objects in the vicinity of the touch position touched by the user, the multitudes of objects are extracted as candidate select objects. The above arrangement allows the user to accurately select an intended object from among the objects extracted as the candidate select objects.

### INDUSTRIAL APPLICABILITY

The inventive object selecting device is useful in easily selecting a specific object from among multitudes of three-dimensionally displayed objects, and is advantageously used for e.g. a mobile apparatus or a digital AV apparatus equipped with a function of drawing three-dimensional objects.

1.-10. (canceled)

11. An object selecting device for allowing a user to select from among a plurality of objects three-dimensionally displayed on a display section, comprising:
a drawing section which determines a display position of each of the objects on the display section, based on a position of each of the objects disposed in a predetermined depth space, to draw each of the objects at the determined display position;
a depth selector which selects a depth selecting position indicating a position for defining the depth space along a depth axis, based on a depth selection command to be inputted from the user; and
a display judger which judges whether each of the objects is located on a forward side or on a rearward side with respect to the depth selecting position in the depth space to extract only the objects located on the rearward side, as objects to be displayed, wherein
the drawing section draws the objects to be displayed which have been extracted by the display judger.

12. The object selecting device according to claim 11, further comprising:
a slide operation section which is slid in a predetermined direction in response to user's manipulation, wherein
the depth selector accepts a slide amount of the slide operation section as the depth selection command to change the depth selecting position in association with the slide amount.

13. The object selecting device according to claim 12, further comprising:
a fine adjustment operation section which finely adjusts the slide amount of the slide operation section in response to user's manipulation, wherein
the slide amount is set in such a manner that a change amount to be displayed on the display section in the case where the fine adjustment section is manipulated by the user is smaller than a change amount to be displayed on the display section in the case where the slide operation section is manipulated by the user.

14. The object selecting device according to claim 13, wherein
the fine adjustment operation section is constituted of a rotary dial, and
the depth selector changes the depth selecting position in cooperation with the slide amount of the slide operation section which is slid by rotating the rotary dial.

15. The object selecting device according to claim 12, wherein
the depth selector increases a change rate of the depth selecting position with respect to a change rate of the slide amount, as the slide amount increases.

16. The object selecting device according to claim 11, wherein
the depth space is divided into a plurality of depth regions along the depth axis,
the object selecting device further includes a select operation section which includes a plurality of selection segments correlated to the respective depth regions and arranged in a certain order with different colors from each other, the select operation section being operable to accept the depth selection command,
the drawing section draws each of the objects, while attaching the same color as the color of the selection segment correlated to the depth region to which each of the objects belongs, and
the depth selector selects a position on a forward-side borderline of the depth region correlated to the selection segment selected by the user with respect to the depth axis, as the depth selecting position.

17. The object selecting device according to claim 11, wherein
the display section is constituted of a touch panel, and
the object selecting device further includes an object selector which selects a forwardmost displayed object, out of the objects to be displayed which are located in a predetermined area away from a touch position on a display image touched by the user.

18. The object selecting device according to claim 17, wherein
the object selector extracts the objects to be displayed, as candidate select objects, the objects to be displayed being located in a predetermined distance range away from a position in the depth space corresponding to the touch position.

19. A computer-readable recording medium which stores an object selecting program which causes a computer to function as an object selecting device for allowing a user to select from among a plurality of objects three-dimensionally displayed on a display section, the object selecting device including:
a drawing section which determines a display position of each of the objects on the display section, based on a position of each of the objects disposed in a predetermined depth space, to draw each of the objects at the determined display position;
a depth selector which selects a depth selecting position indicating a position for defining the depth space along a depth axis, based on a depth selection command to be inputted from the user; and
a display judger which judges whether each of the objects is located on a forward side or on a rearward side with respect to the depth selecting position in the depth space to extract only the objects located on the rearward side, as objects to be displayed, wherein
the drawing section draws the objects to be displayed which have been extracted by the display judger.

20. An object selecting method for allowing a user to select from among a plurality of objects three-dimensionally displayed on a display section, comprising:
a drawing step of causing a computer to determine a display position of each of the objects on the display section, based on a position of each of the objects disposed in a predetermined depth space, to draw each of the objects at the determined display position;
a depth selecting step of causing the computer to select a depth selecting position indicating a position for defining the depth space along a depth axis, based on a depth selection command to be inputted from the user; and
a display judging step of causing the computer to judge whether each of the objects is located on a forward side or on a rearward side with respect to the depth selecting position in the depth space to extract only the objects located on the rearward side, as objects to be displayed, wherein
in the drawing step, the objects to be displayed which have been extracted in the display judging step are drawn.
